(19) United States
(12) Patent Application Publication
(10) Pub. No.: US 2026/0086615 A1
(43) Pub. Date: Mar. 26, 2026

(54) Power State Selection Based on Circuit Activity

(71) Applicant: Apple Inc., Cupertino, CA (US)

(72) Inventors: Doron Rajwan, Rishon LeZion (IL); Daniel U. Becker, San Jose, CA (US); John H. Kelm, Belmont, CA (US); Michael Bekerman, Los Gatos, CA (US); Nidhi Nidhi, San Jose, CA (US)

(21) Appl. No.: 18/898,152

(22) Filed: Sep. 26, 2024

(51) Int. Cl. G06F 1/26

(52) U.S. Cl. CPC G06F 1/26

(57) ABSTRACT

A system includes a power management processor that may be configured to monitor operation of one or more circuit blocks in the system, and to determine a particular performance state of a set of performance states for one or more power domains in the system based on the monitored operation. The system further includes a performance management circuit that may be configured to receive, from the power management processor, an indication of the particular performance state. The performance management circuit may further be configured to determine a transition path from a current performance state to the particular performance state that avoids illegal performance state transitions, and to cause a control circuit to transition to the particular performance state using the transition path.

### BACKGROUND

### Technical Field

Embodiments described herein are related to computing systems, including computer systems implemented as systems-on-a-chip (SoCs) and multichip packages. More particularly, embodiments are disclosed to techniques for managing power state transitions in a computer system.

### Description of the Related Art

Computer systems, including systems-on-chip (SoCs) and multi-die chip packages, may utilize a variety of performance states to increase efficiency while performing a variety of tasks. For example, a multicore SoC may be capable of placing cores and/or core complexes independently into one of multiple performance states. As used herein, a “performance state” refers to a particular combination of operating parameters including, e.g., voltage levels of one or more power supply signals and frequencies of one or more clock signals. If a given circuit block is performing a compute intensive task, then the given circuit block may be placed into a high-performance state to increase its ability to perform and complete the compute intensive task. If the given circuit block is performing a background task requiring less computational bandwidth, then the second circuit block may be placed into a lower performance state with enough capability to perform the background task without consuming excess power and/or generating excess heat.

In an SoC with a plurality of circuit blocks, providing individual power signals and clock signals to each circuit block may be overly complex. To reduce complexity of power management, the various circuit blocks may be grouped into a suitable number of groups with each group sharing a particular number of power signals and/or clock signals. The circuit blocks may be grouped based on a variety of criteria, such as by function, by physical location on an integrated circuit, by power demand, and the like. The circuit blocks of a given group may then be coupled to a common set of power rails and clock sources.

### BRIEF DESCRIPTION OF THE DRAWINGS

The following detailed description makes reference to the accompanying drawings, which are now briefly described.

FIG. 1 illustrates a block diagram of an embodiment of a computer system with a plurality of circuit blocks, including a performance management circuit.

FIG. 2 shows a block diagram of an embodiment of a computer system that includes a set of performance state tables, lockout circuit, and a performance management circuit.

FIG. 3 depicts a block diagram of an embodiment of a computer system that includes multiple power rails supplying a plurality of different circuit blocks, including a performance management circuit, processor circuits, and others.

FIG. 4 illustrates a flow diagram of an embodiment of a method for managing selection of a performance state by a performance management circuit.

FIG. 5 depicts a flow diagram of an embodiment of a method for initializing performance state tables to be used by a performance management circuit.

FIG. 6 shows a flow diagram of an embodiment of a method for selecting a performance state based on a change in status of a high-demand circuit block.

FIG. 7 shows various embodiments of systems that include integrated circuits that utilize the disclosed techniques.

FIG. 8 is a block diagram of an example computer-readable medium, according to some embodiments.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims.

### DETAILED DESCRIPTION OF EMBODIMENTS

Some ICs with a need to manage performance states for multiple circuit blocks may utilize a performance management circuit (PMC) to control selection of performance states for the various circuits as well as managing transitions between the various performance states. The PMC may determine power policy and use state machines and or other control circuits for setting voltages of the various power rails and frequencies of various clock sources. In addition, the PMC may prevent a transition to performance states that are prohibited per the power policy. IC designs continue to become more capable with increased numbers of various circuit blocks, e.g., application processors, graphics processing units (GPUs), neural engines, security processors, image sensor processors, audio processors, and the like.

Managing a given power rail or given clock source may include determining an appropriate common voltage level for all the circuit blocks coupled to the given power rail as well as a common clock frequency for all circuit blocks coupled to the common clock source. Accordingly, increasing voltage level and clock frequency to improve performance must be balanced with decreasing voltage level and clock frequency to reduce power consumption and thermal emissions. To increase flexibility in selecting an appropriate performance state, a plurality of voltage levels and clock frequencies may be available for the common power rail and clock source, respectively.

Several concerns are associated with selection of an appropriate performance state. In typical systems, for example, frequency of the common clock source and voltage level of the common power rail are not completely independent of one another. To increase frequency for an increase in performance bandwidth, an associated increase in voltage level may be required. Conversely, to reduce a voltage level to conserve power may require an associated decrease of the current frequency. In addition, activity of circuit blocks coupled to a common power rail may cause the common power rail to reach a peak current that it can supply.

When balancing performance bandwidth across an IC, consideration may be given to types of transactions that the various circuit blocks will be sending in relation to a maximum throughput of a communication fabric linking the circuit blocks. Two common types of transactions are bulk and real time. Bulk transactions may have a lowest priority and may frequently be used when delays for a transaction data packet to reach a destination block are not critical, such as flushing data from a cache memory to a system memory. Real time transactions, in contrast, may be a high (or highest) priority transaction used when transaction data is needed at the destination block as soon as possible, and delays may cause noticeable performance issues. For example, a camera system in a smartphone may use real time transactions to send image data to a display driver for a user to capture a desired image. In such a case, delays may cause the user to miss the desired shot.

Several techniques for managing performance bandwidth of a computer system include allotting a portion of available bandwidth to real time transactions, using a higher than typical combination of power rail voltage level and clock source frequency that enable increased bandwidth, and dynamic voltage margins that allow a temporary increase in clock signal frequency without a corresponding increase in power rail voltage level. All of these techniques may be dependent on a current state of an IC, including, for example, activity levels of particular high demand circuit blocks.

Circuits and techniques are proposed herein for a computer system with a performance management circuit that is capable of receiving performance state requests from a plurality of circuit blocks, including a high-demand circuit block, that are coupled to a common power rail and clock source. Such performance state requests may include respective desired voltage levels for the power rail and respective desired frequencies for the clock signal. Based on a determination that the high-demand circuit block is idle, The performance management circuit may permit selection of performance states with a highest voltage level for the power rail. Otherwise, if the high-demand circuit block is active, the performance management circuit may restrict use of performance states that use the highest voltage level.

For the ease of discussion, various embodiments in this disclosure are described as being implemented using one or more SoCs. It is to be understood that any disclosed SoC can also be implemented using a chiplet-based architecture. Accordingly, wherever the term “SoC” appears in this disclosure, those references are intended to also suggest embodiments in which the same functionality is implemented via a less monolithic architecture, such as via multiple chiplets, which may be included in a single package in some embodiments.

On a related note, some embodiments may include more than one SoC. Such architectures are to be understood to encompass both homogeneous designs (in which each SoC includes identical or almost identical functionality) and heterogeneous designs (in which the functionality of each SoC diverges more considerably). Such disclosure also contemplates embodiments in which the functionalities of the multiple SoCs are implemented using different levels of discreteness. For example, the functionality of a first system could be implemented on a single IC, while the functionality of a second system (which could be the same or different than the first system) could be implemented using a number of co-packaged chiplets.

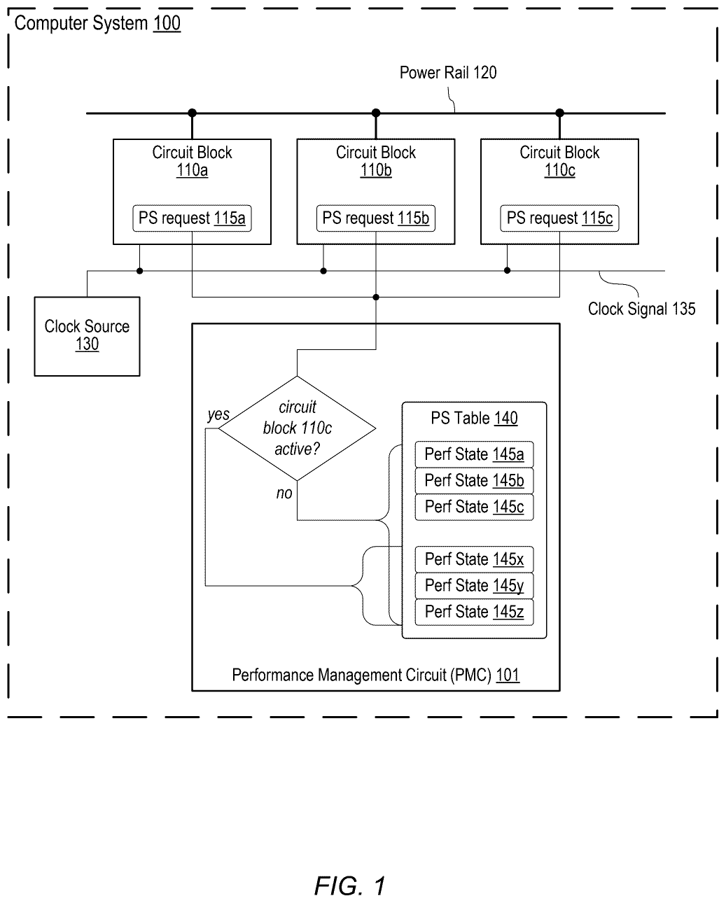

FIG. 1 illustrates a block diagram of an embodiment of a computer system that uses a performance management circuit to select a performance state based on a state of a high-demand circuit block. Computer system 100 includes a plurality of circuit blocks 110a-110c (collectively 110) that are coupled to power rail 120 and clock source 130. Circuit blocks 110 are also coupled to performance management circuit (PMC) 101 which, in turn, includes performance state (PS) table 140. PS table 140 includes a plurality of entries indicative of performance states 145a-145z (collectively 145, not all states shown). In some embodiments, computer system 100 may be implemented using one or more integrated circuits, which may be included in a larger system, such as a desktop or laptop computer, a smartphone, a tablet computer, a wearable smart device, or the like.

Circuit blocks 110 may include central processing units (CPUs), graphics processing units (GPUs), neural processing engines, memory controllers, display controllers, camera sensors, image signal processors, and other various peripherals. As such, circuit blocks 110 may perform a wide variety of tasks, with tasks ranging from simpler background tasks to more intensive computational tasks. Depending on current tasks being performed, a given circuit block 110 may require a higher performance state to complete the current task in a timely manner or may be capable of completing the current task in a lower performance state, allowing computer system 100 to conserve power. For example, a camera sensor and image signal processor may be used to capture images and send the images to a display driver for a user of a device that includes computer system 100 to observe. During the image data capture and subsequent image data processing, the image signal processor may require a higher performance state to complete the tasks in a short amount of time based on user expectations to see live images displayed with no discernable delay. When this camera sensor is off, the image signal processor may be placed into a lower performance state, including for example, an idle state, thereby conserving power and reducing thermal output.

A higher performance state is typically enabled by raising a voltage level of a power supply and/or increasing a frequency of a clock signal. Increased clock frequencies may cause a circuit block to process commands faster and the increased voltage levels may provide necessary power to support the increased frequencies. As shown, circuit blocks 110 are coupled to a common power rail 120 and to a common clock source 130 that generates clock signal 135. In the present example, at least one of circuit blocks 110 is designated as a high-demand circuit block, e.g., circuit block 110c. A “high-demand” circuit block, as used herein, refers to a circuit block that, at least in certain circumstances, draws a high amount of current when active. For example, many CPUs and GPUs may be considered high-demand circuit blocks as such circuits commonly consume a large amount of current when operating at or near their maximum frequencies. Accordingly, such circuits may be placed on their own power rail to avoid starving other circuit blocks.

Other high-demand circuit blocks may include image signal processors and neural processing engines. These examples may generate a large amount of memory transactions in addition to operating at high clock frequencies to, for example, manipulate or analyze images from the camera sensor. An image signal processor may perform various filtering algorithms and image enhancements on captured image data. This captured image data may further be analyzed by the neural processing engine to, e.g., perform facial recognition operations. Such operations, however, may not be performed with a high frequency in some embodiments, such as a smartphone that spends a majority of a day idle in a user's pocket, playing music, surfing the Internet, and the like. Accordingly, circuit blocks such as an image processing sensor and/or a neural processing engine may share a power rail with other circuit blocks since they may typically be idle and, therefore, allow the other circuit blocks to consume as much current from the common power rail as needed. During the occasions when these high-demand circuit blocks are active, however, performance states may be managed to avoid overloading the common power rail and potentially current starving one or more circuit blocks on the common power rail.

As illustrated, performance management circuit (PMC) 101 may be configured to receive performance state requests 115a-115c (collectively 115) from circuit blocks 110. A given performance state request may include requests for a respective voltage level for power rail 120 and a respective frequency for clock signal 135. In various embodiments, performance state requests 115 may be sent to PMC 101 as performance requirements change for a given circuit block 110, in a periodic manner, in response to a request from PMC 101, or combinations thereof.

Based on a determination that the high-demand circuit block 110c is idle, PMC 101 may be configured to permit selection of performance states 145 with a highest voltage level. As shown, performance state table 140 includes performance state 145a-145z. Performance states 145a-145c may, for example, call for a highest allowable voltage level for power rail 120. When high-demand circuit block 110c is determined to be idle, all of performance states 145, including 145a-145c, may be eligible for selection based on the received performance state requests 115. A voltage level specified by performance states 145a-145c may be an overdrive voltage level. In some embodiments, an overdrive voltage level refers to a voltage level that may be out of specification for a design of computer system 100 under certain operating conditions, such as when computer system 100 is above a threshold temperature. In other embodiments, an overdrive voltage level refers to a voltage level that may reduce a typical safe operating margin for computer system 100. Accordingly, use of performance states 145a-145c may, in some embodiments, be limited to certain conditions and/or for limited amounts of time.

As illustrated, PMC 101 may be further configured to, based on a determination that high-demand circuit block 110c is active, limit performance state selection to a portion of the plurality of performance states 145 that excludes performance states 145a-145c with the highest voltage level. In some embodiments, PMC 101 may receive, or have access to, an indicator, such as an enable bit, that signifies if circuit block 110c is enabled (active) or disabled (idle). In other embodiments, PMC 101 may be configured to identify a particular level of activity of circuit block 110c, including levels between idle and fully active. For example, performance state request 115c received from circuit block 110c may be indicative of a current workload that circuit block 110c is managing. In such embodiments, PMC 101 may be further configured to increase or decrease a number of performance states 145 that are eligible for selection based on the determined level of activity of circuit block 110c.

When circuit block 110c is determined to be active and eligible performance states 145 are limited to exclude performance states 145a-145c, if any of the received performance state requests 115 indicate a preference for any of performance states 145a-145c, then PMC 101 may be configured to select one of the eligible performance states 145x-145z that is closest to the requested state. For example, if a highest performance state 145 includes a highest available voltage level for power rail 120 and a highest available frequency for clock signal 135, then one of the eligible performance states 145 with a next highest voltage level for power rail 120 may be selected along with a highest frequency allowable for the next highest voltage level.

If a selected performance state 145 is implemented due to determined activity in circuit block 110c, then PMC 101 may be further configured to determine, at a subsequent point in time, that circuit block 110c has become idle. In response to such a determination, PMC 101 may be further configured to, based on the received performance state requests 115, permit selection of performance states 145a-145c with the highest voltage level for power rail 120. For example, if performance state 145b was the desired performance state based on the previously received performance state request 115a, and circuit block 110a has not updated this request, then PMC 101 may select performance state 145b in response to the determination that circuit block 110c is currently idle.

By limiting performance states based on activity of a high-demand circuit block, such high-demand circuit blocks may be implemented to utilize common power rails with other circuit blocks. Such a capability may simplify power routing of an integrated circuit design, as well as reduce a number of voltage levels that need to be concurrently generated for the integrated circuit. This simplification may reduce costs and/or die size of the integrated circuit, as well as simplify power management circuitry.

It is noted that the system of FIG. 1, is merely an example. Computer system 100 has been simplified to highlight features relevant to this disclosure. Elements not used to describe the details of the disclosed concepts have been omitted. For example, computer system 100 may include various additional circuits that are not illustrated, such as one or more power supply circuits, memory circuits, communication fabrics, and the like. Although only three circuit blocks and six performance states are shown, any suitable number of such elements may be included in a given system. It is further contemplated that more than one high-demand circuit block may be coupled to a given power rail. In such embodiments, PMC 101 may be configured to determine a state of each high-demand circuit block and limit performance states based on the combination of their states.

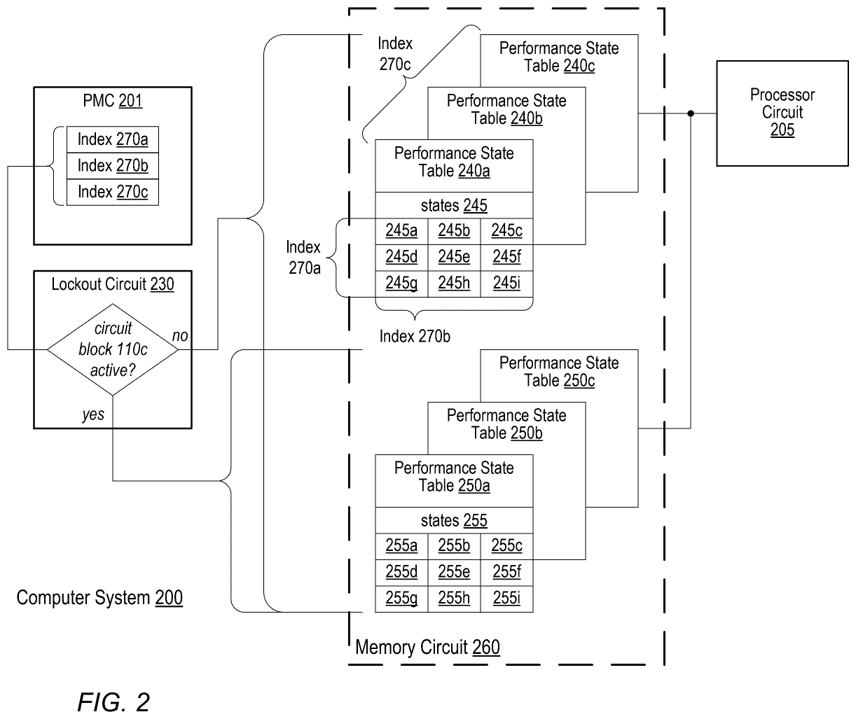

In FIG. 1, PMC 101 is described as using status of a high-demand circuit block when selecting a particular performance state from a plurality of performance states. Management of performance states may be implemented using a variety of techniques. An example for managing performance states for a group of circuit blocks is depicted in FIG. 2.

Moving to FIG. 2, a block diagram of a system that includes state request registers is shown. Computer system 200 includes PMC 201, processor circuit 205, lockout circuit 230, a first set of performance state tables 240a-240c (collectively 240), and a second set of performance state tables 250a-2450c (collectively 250). Performance state tables 240 include a plurality of performance states 245 and performance state tables 250 similarly include a plurality of performance states 255. A given performance state is selected based on indices 270a-260c (collectively 260). As illustrated, index 270c is used to select a particular table while indices 270a and 260b are used to select a given performance state from the selected table.

As illustrated memory circuit 260 may be configured to store sets of performance state tables 240 and 250. Although illustrated as a plurality of tables, it is contemplated that any suitable type of data structure may be utilized to store and manage the plurality of performance states 245 and 255. Processor circuit 205 may be configured to, based on an indication of a system boot operation for computer system 200, populate performance state tables 240 and 250 with a set of permissible performance states 245 and 255. To populate performance state tables 240 and 250, processor circuit 205 may be configured to map ones of the possible combinations of table indices 270 into the table to a corresponding entry in one of performance state tables 240 or 250. Each entry in performance state tables 240 and 250 corresponds to one a particular performance state. In some embodiments, two or more entries in either of performance state tables 240 and 250 may indicate the same performance state 245 or 255, e.g., two different sets of indices 270 may be mapped to entries that point to a common performance state. However, all valid combinations of values used as indices 270 may be mapped to a respective entry in performance state tables 240 or 250.

In various embodiments, any suitable values may be used for indices 270. For example, index 270a may be an indication associated with performance state requests 115 in FIG. 1. Performance state requests 115 may indicate a performance need of the respective circuit block 110 by including an integer value ranging between, e.g., one (lowest need) to eight (highest need). Index 260b may be indicative of one or more current operating conditions of computer system 200, such as current temperature, state of a power supply (e.g., battery level), and the like. Index 260c may be a value indicating a current activity level across computer system 200. For example, performance states 245 and 255 may be associated with a subset of circuit blocks from a total set of circuit blocks included throughout computer system 200. Accordingly, activity of other circuit blocks not related to the performance state 245 and 255 may limit currently available ones of performance states 245 and 255. These are merely examples of values that can be used as indices 270. In other embodiments, any applicable values may be used to determine any suitable number of performance state table indices.

In the present example, a given performance state includes a combination of one or more power rail voltage levels and one or more clock signal frequencies. In some embodiments, certain combinations of voltage level and frequency may not be valid for a given system. For example, a highest clock signal frequency may be too fast to run at a lowest power rail voltage, or frequency and/or voltage may be limited based on a given circuit block being active. Accordingly, the entries of performance state tables 240 and 250 may omit one or more possible combinations of power rail voltage level, clock signal frequency, and enabled high power circuit blocks.

Based on an indication that the system boot operation is complete, and therefore the entries in performance state tables 240 and 250 have been populated, PMC 201 may be further configured to set a lock in memory circuit 260 to prevent changes to performance state tables 240 and 250. If performance state tables 240 and 250 were to be corrupted, either by accident or by an attempted hacking attack, then computer system 200 could be placed into an out-of-spec operating condition that could cause computer system 200 to behave in an unexpected manner. To mitigate risk of performance state tables 240 and 250 being corrupted, a write lock may be enabled on memory circuit 260 (or a subset of memory circuit 260 where performance state tables 240 and 250 are stored) to prevent any write accesses from being performed on the locked memory locations. Read accesses may be maintained while the memory lock is enabled to allow PMC 201 to access performance state tables 240 and 250.

As described above in regard to FIG. 1, if a high-demand circuit block is enabled, then some portion of valid performance states may be restricted from selection. As illustrated, lockout circuit 230 is a hardware lockout circuit that is configured to block access to performance state tables 240. To limit the performance state selection, PMC 201 may be configured to activate lockout circuit 230. When activated, lockout circuit 230 may prevent indices 270 from accessing any of performance state tables 240, thereby limiting selection to one of performance states 255 in performance state tables 250. This may be accomplished by changing a bit in one of indices 270. For example, index 270c may be used to select a particular performance state table to access for the performance state selection. In such embodiments, one particular bit of index 270c may be used to select one of performance state tables 240 when the particular bit is clear and select one of performance state tables 250 if the particular bit is set. If the high-demand circuit block is enabled, then lockout circuit 230 may force the particular bit of index 270c to read as set, thereby forcing a selection from performance state tables 250. Such a lockout circuit may be an effective technique for preventing access to restricted performance states while a high-demand circuit block is active.

In some embodiments, an indication of activity of a high-demand circuit block may be received from a processor circuit that is executing code that utilizes the high-demand circuit block. For example, processor circuit 205 may be configured to execute code that uses an image signal processor that is defined in computer system 200 as a high-demand circuit block. The code may call an application programming interface (API) to activate the high-demand circuit block. This API may be configured to send an indication of the activation of the high-demand circuit block to PMC 201. In turn, PMC 201 may be further configured to activate, in response to the indication, lockout circuit 230. It is contemplated that other techniques may be used to identify activity of a high-demand circuit block and, in response, activate lockout circuit 230.

Use of a hardware lockout circuit to prevent access to restricted performance states while a high-demand circuit block is active may, in some embodiments, provide a safer method for preventing unintended (or improperly selected) use of a restricted performance state during times when a high-demand circuit block might result in operation in a restricted state causing a system failure or otherwise compromised system operation.

It is noted that the example shown in FIG. 2 is one depiction of organizing and managing performance state utilizing the disclosed techniques. Although shown as different sets of performance state tables, in other embodiments, any suitable data structure may be used to implement the performance states. The performance states are shown as being values stored in a memory circuit. In other embodiments, other types of storage circuits (e.g., registers, or hard-coded values) may be used to store the various valid states. Although three rows and three columns are shown for performance state tables 240a and 250a, any number of columns and rows, including unequal numbers of columns and rows, may be included in other embodiments.

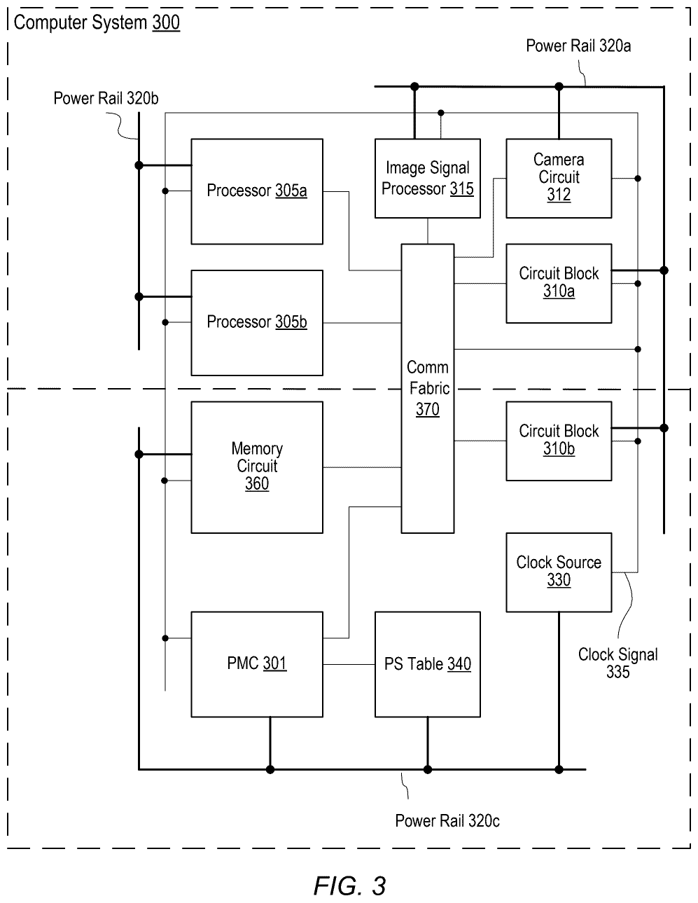

In the descriptions of FIGS. 1 and 2, use of a single power rail is discussed. In other systems, a plurality of power rails may be implemented. An example of a computer system in which three power rails are used is illustrated in FIG. 3.

Turning to FIG. 3, a block diagram of an embodiment of a computer system that uses that uses a performance management circuit to manage a plurality of power rails, including managing operation of at least one power rail based on a state of a high-demand circuit block is illustrated. Three power rails (320a, 320b, and 320c, collectively 320) are shown in computer system 300. Computer system 300 includes circuit blocks 310a and 310b (collectively 310), camera circuit 312, and image signal processor 315 all coupled to power rail 320a, processors 305a and 305b (collectively 305) coupled to power rail 320b, and PMC 301, power state (PS) table 340, clock source 330, and memory circuit 360 coupled to power rail 320c. Computer system 300 further includes communication fabric 370 configured to support transfer of transactions among these circuit blocks. Clock source 330 generates clock signal 335 that is routed to circuit blocks that are coupled to ones of the three power rails 320. In various embodiments, computer system 300 is implemented on one or more co-packaged integrated circuits (ICs). As indicated by the dotted line, computer system 300 may be implemented across two ICs, with communication fabric 370 providing communication across the die-to-die boundary.

As illustrated, computer system includes circuit blocks 310, camera circuit 312, and image signal processor 315 coupled to common power rail 320a. These circuit blocks may be configured to generate real-time (RT) transactions and/or bulk transactions, wherein the bulk transactions have a lower priority than RT transactions. In addition, these circuit blocks may be configured to send requests for a respective performance state of a plurality of performance states (e.g., performance states 145 in FIG. 1), wherein a given one of the plurality of performance states may include an indication for a respective voltage level for power rail 320a. These performance state requests may also include an indication of a requested frequency for clock signal 335.

Communication fabric 370 may, as shown, be configured to transfer RT transactions and bulk transactions between ones of the plurality of circuit blocks in computer system 300. In various embodiments, communication fabric 370 includes one or more networks that may further include various combinations of network switches, access points, network hubs, and the like for transferring a given transaction, RT or bulk, from a source circuit block to a destination circuit block. Communication fabric 370 may be configured to prioritize RT transactions over bulk transactions, for example, by allocating a particular portion of network resources to RT transactions, relegating bulk transactions to the remaining, unallocated portion. Such an allocation of resources may be implemented using any suitable technique.

In some embodiments, PMC 301 may correspond to either of PMCs 101 and/or 201 as shown in FIGS. 1 and 2. Accordingly, PMC 301 may be configured to receive the requests for the respective performance states from the plurality of circuit blocks. Based on a determination that a high-demand circuit block is enabled, PMC 301 may be further configured to select, based on the received power state requests, one of a subset of the plurality of performance states, wherein the subset excludes performance states with a highest voltage level for power rail 320a. For example, a high power demand by a high-demand circuit block may cause voltage droop on power rail 320a, particularly if other circuits coupled to power rail 320a are also active and drawing significant amounts of power.

For example, image signal processor 315 may be configured to receive image data from camera circuit 312 and perform one or more operations on the received image data before sending the image data to a display driver circuit (e.g., circuit block 310b) to be shown on a display included in, or coupled to computer system 300. Such operations may include applying one or more image filters, facial/object recognition, image stabilization (if the image is part of a video stream) and the like. Image data may include a very large amount of data, and transfer of image data from camera circuit 312 to the display may be treated as a real-time process requiring RT transactions to prevent starving the display driver from images to display. Accordingly, image signal processor 315 may be considered a high-demand circuit block.

In addition to restricting use of performance states with a highest voltage level, PMC 301 may be further configured to limit an amount of bandwidth of communication fabric 370 that is allotted to RT transactions. For example, based on a determination that image signal processor 315 is active, PMC 301 may be configured to limit RT transactions to a first percentage of available bandwidth of communication fabric 370. While this may appear counter-intuitive, limiting available RT transaction bandwidth may reduce power consumption of image signal processor 315 by limiting its ability to receive unprocessed image data and/or send processed image data. In addition, limiting RT bandwidth may reserve bulk bandwidth for other circuit blocks in computer system 300, allowing other circuits to complete their respective tasks and potentially enter reduced power modes, thereby reducing overall power demand across computer system 300.

As shown, PMC 301 may also be configured to, based on a determination that image signal processor 315 is idle or disabled, limit RT transactions to a second percentage, higher than the first percentage, of available bandwidth of communication fabric 370. At times when image signal processor 315 is not active and, therefore, is not consuming a significant amount of power while simultaneously receiving and generating a number of RT transactions, the RT bandwidth allocation may be increased, thereby allowing other non-high-demand circuit blocks to utilize RT transactions to complete data transactions in an efficient manner, thereby allowing these non-high-demand circuit blocks to complete tasks and return to idle states.

PMC 301 may additionally be configured to determine an associated frequency of clock source 330 for the plurality of circuit blocks based on a current voltage level of power rail 320a, and adjust the associated frequency based a current safe operating margin. A total power consumption of a given active circuit block may be directly impacted by a combination of a voltage of the associated power rail and the frequency of a clock signal that causes logic circuits to transition logic values. A higher operating voltage corresponds to more power to cause a single logic transition. A higher clock frequency corresponds to more logic transitions within a given amount of time. Accordingly, increases in both voltage and frequency may cause a significant increase in power consumption for a given circuit block. A safe operating margin may be used by circuit designers to mitigate risk of a power rail becoming overloaded, resulting in possible voltage droop and current starvation of the circuit blocks supplied by the power rail. In some embodiments, PMC 301 may be further configured to increase the safe operating margin based on the determination that image signal processor 315 block is enabled, thereby reducing a risk of voltage droop on power rail 320a.

It is noted that the computer system depicted in FIG. 3 is merely an example to demonstrate the disclosed concepts. Although a particular configuration of circuit elements is depicted, any suitable configuration is contemplated in other embodiments. For example, a signal processor circuit or additional processor circuits may be included in other embodiments. Although three power rails are shown, any number of power rails may be utilized.

To summarize, various embodiments of an apparatus are disclosed, including a computer system that is implemented on one or more co-packaged integrated circuits (ICs) and that includes a plurality of circuit blocks and a performance management circuit (PMC). The plurality of circuit blocks may be coupled to a common power rail and clock signal. At least one of the plurality of circuit blocks may be designated as a high-demand circuit block. The PMC may be configured to receive performance state requests from the plurality of circuit blocks. A given one of a plurality of performance states may include a respective voltage level for the power rail and a respective frequency of the clock signal. Based on a determination that the high-demand circuit block is idle, The PMC may be further configured to permit selection of the performance states with a highest voltage level. Based on a determination that the high-demand circuit block is active, the PMC may be further configured to limit performance state selection to a portion of the plurality of performance states that excludes performance states with the highest voltage level.

In a further example, the at least one high-demand circuit block may include an image signal processor. Another example may further include a memory circuit configured to store a performance state table and a processor circuit. The processor circuit may be configured to, based on an indication of a system boot operation, populate the performance state table with a set of permissible performance states. Based on an indication that the system boot operation is complete, the processor circuit may be further configured to set a lock in the memory to prevent changes to the performance state table.

In another example, to populate the performance state table, the processor circuit may be configured to map ones of the possible combinations of table indices into the table to a corresponding entry in the table. The entries of the performance state table may omit one or more possible combinations of power rail voltage level, clock signal frequency, and enabled high power circuit blocks.

A further example may also comprise a hardware lockout circuit that is configured to block access to the portion of the performance states. To limit the performance state selection, the PMC may be configured to activate the hardware lockout circuit.

Another example may further include a processor circuit configured to call an application programming interface (API) to activate the high-demand circuit block, and to send an indication of the activation of the high-demand circuit block to the PMC. The PMC may be further configured to activate, in response to the indication, the hardware lockout circuit. In an example, the PMC may be further configured to determine that the high-demand circuit block is idle. Based on the received performance state requests, the PMC may be further configured to permit selection of the performance states with the highest voltage level.

An example embodiment may further include a communication fabric that may be configured to transfer real-time (RT) transactions and bulk transactions. The PMC may be further configured to, based on a determination that the high-demand circuit block is active, limit real-time transactions to a first percentage of available bandwidth of the communication fabric. Based on a determination that the high-demand circuit block is idle, the PMC may be further configured to limit real-time transactions to a second percentage, higher than the first percentage, of available bandwidth of the communication fabric.

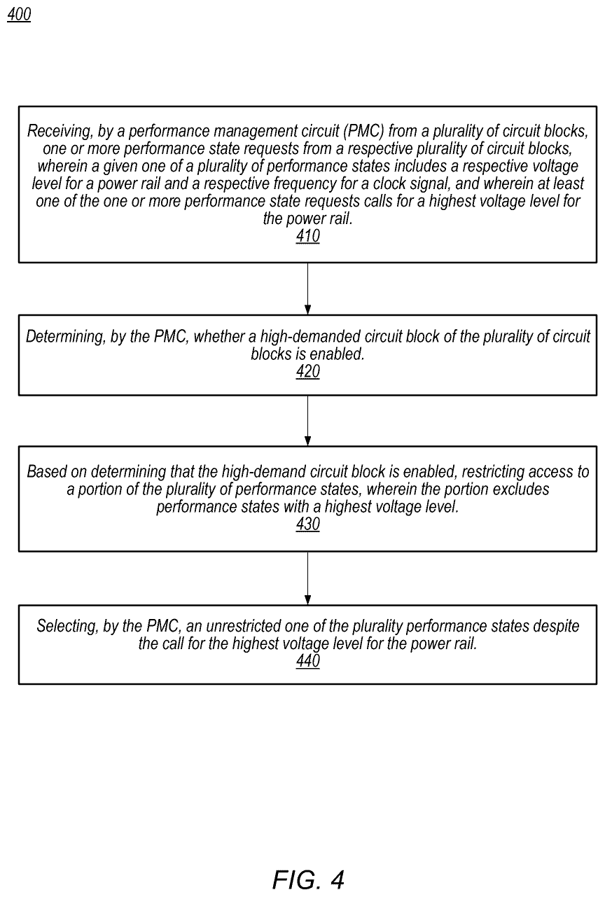

The circuits and techniques described above in regards to FIGS. 1-3 may be performed using a variety of methods. Methods associated with operation of a performance management circuit are described below in regards to FIGS. 4-6.

Proceeding to FIG. 4, a flow diagram for an embodiment of a method for managing performance states of a computer system with one or more high-demand circuit blocks is illustrated. Method 400 may be used in conjunction with any of the computer circuitry, systems, devices, elements, or components disclosed herein, such as computer systems 100 to 300 in FIGS. 1-3. In some embodiments, at least some of the operations of method 400 may be performed using instructions included in a non-transitory, computer-readable storage medium having program instructions that are executable by a processing circuit in the disclosed systems to cause the operations described with reference to FIG. 4. Method 400 is described below using computer system 100 of FIG. 1 as an example. References to elements in FIG. 1 are included as non-limiting examples.

As illustrated, method 400 begins in block 410 with a performance management circuit (PMC) of a computer system implemented on one or more co-packaged integrated circuits (ICs), receiving one or more performance state requests from a respective plurality of circuit blocks. For example, circuit blocks 110 may send respective performance state requests 115 to PMC 101. A given one of performance state requests 115 may provide an indication of a respective voltage level for power rail 120 and a respective frequency for clock signal 135. In the present example, at least one of performance state requests 115 calls for a highest voltage level for power rail 120. For example, circuit block 110b may be performing a compute intensive task and request a highest performance state that includes a highest voltage level as well as a highest frequency for clock signal 135. In various embodiments, performance state requests 115 may be sent to PMC 101 for various reasons. A given one of performance state requests 115 may be sent due to a change in performance requirements for a respective one of circuit blocks 110. Performance state requests 115 may be sent, by respective circuit blocks 110, in a periodic manner, and/or in response to a request from PMC 101.

Method 400 continues at block 420 with the PMC determining whether a high-demand circuit block of the plurality of circuit blocks is enabled. For example, circuit block 110c is depicted as a high-demand circuit block. As disclosed above, a high-demand circuit block may be a circuit that consumes more current than most, or all, of the other circuit blocks coupled to a same power rail. In some embodiments, circuit blocks that may operate at a higher clock frequency than the other circuit blocks coupled to the same power rail may also be considered high-demand. Designation as a high-demand circuit block may be hard-wired in the design of computer system 100, or may be a software/firmware programmable designation as part of an operating system and/or a system boot code. In some embodiments, PMC 101 may include a processor core that is capable of executing firmware to perform some or all of the operations of the PMC described herein. In such embodiments, designation of high-demand circuit blocks may be encoded in firmware for the processor core.

PMC 101 may determine whether circuit block 110c is enabled via a variety of techniques. PMC 101 may, e.g., using one or more register circuits, track a last received performance state request 115 for each circuit block 110. PMC 101 may use these requests to determine if circuit block 110c is enabled. In such embodiments, if the last received performance state request 115c is for any state above a particular threshold state, then PMC 101 may consider circuit block 110c as being enabled. In other embodiments, PMC 101 may receive or poll an enable bit that is associated with the current state of circuit block 110c.

At block 430, method 400 continues with the PMC, based on determining that the high-demand circuit block is enabled, restricting access to a portion of the plurality of performance states. As depicted in FIG. 1, performance states 145a-145c include use of the highest voltage level for power rail 120, while performance states 145x-145z call for voltage levels of power rail 120 to be less than the highest voltage level. The portion excludes performance states with a highest voltage level. In response to determining that circuit block 110c is active, for example, PMC 101 may block access to performance states 145a-145c, thereby leaving performance states 145x-145z as the portion of performance states that are available for selection. In some embodiments, restricting the access to the portion of performance states 145 may include activating, by PMC 101, a hardware lockout circuit (e.g., lockout circuit 230) that prevents selection of the highest voltage level. Such a lockout circuit may prevent, as shown, selection of a performance state that includes activation of a highest voltage level. In other embodiments, a hardware lockout circuit may allow selection of performance states calling for the highest voltage level but instead cause a lower voltage level to be supplied to power rail 120.

Method 400 further continues at block 440 with the PMC selecting an unrestricted one of the plurality performance states despite the call for the highest voltage level for the power rail. As illustrated, PMC 101 selects one of performance states 145x-145z from the unrestricted portion of performance states 145. PMC 101 may be configured to select one of performance states 145x-145z based on which state is closest to the requested performance state. For example, if the requested performance state is for a highest voltage and fastest frequency, then PMC 101 may select the one of performance states 145x-145z with the highest permissible voltage and fastest permissible frequency.

In some embodiments, method 400 may be further include limiting, by PMC 101 based on the determining circuit block 110c is enabled, real-time transactions to a first percentage of available bandwidth of a communication fabric of computer system 100. Although not shown, computer system 100 may include a communication fabric that supports a combination of RT and bulk transactions, such as described above for computer system 300 in FIG. 3. As RT transaction may be associated with high-demand circuit block activity, limiting RT bandwidth in the communication fabric may have a further effect of reducing power consumption from high-demand activity.

By limiting performance states based on activity of a high-demand circuit block, high-demand circuit blocks may be coupled to common power rails with other circuit blocks, thereby simplifying power routing in a computer system. In addition, a number of voltage levels that need to be concurrently generated for the integrated circuit may be reduced. Implementation of such techniques may reduce costs and/or die size of the integrated circuit, as well as simplify power management circuitry.

It is noted that the method of FIG. 4 includes blocks 410-440. Method 400 may end in block 440 or may repeat some or all blocks of the method. For example, method 400 may repeat for other power rails included in computer system 100. In some cases, blocks of method 400, or a portion thereof, may be performed concurrently with other blocks of the method. For example, blocks 410 and 420 may be performed concurrently, or in a different order based on how the PMC determines activity of high-demand circuit blocks.

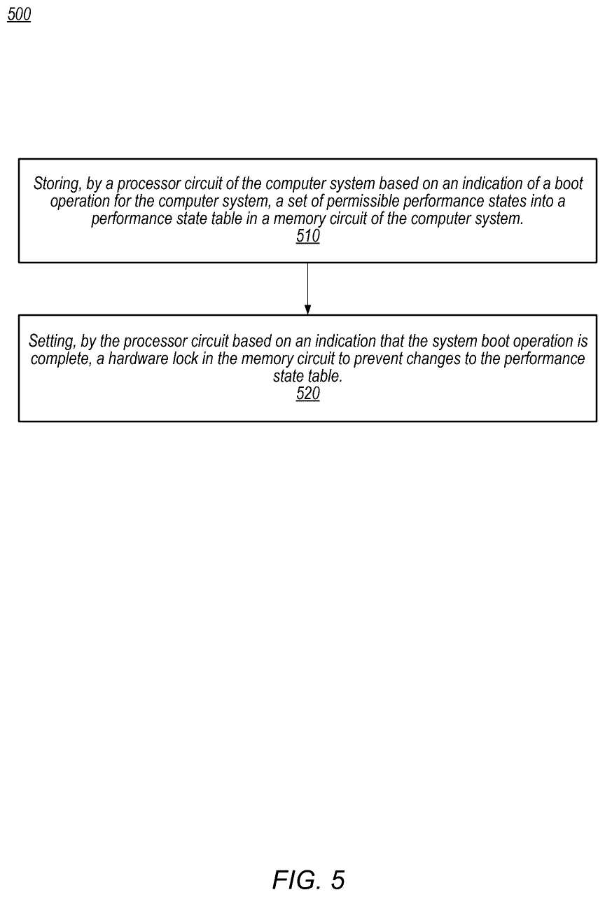

Moving now to FIG. 5, a flow diagram for an embodiment of a method for initializing performance state tables by a performance management circuit is illustrated. Similar to method 400, method 500 may be used in conjunction with any of the computer circuitry, systems, devices, elements, or components disclosed herein, including any of computer systems 100-300. Some or all of the operations of method 500, in some embodiments, may be performed using instructions included in a non-transitory, computer-readable storage medium having program instructions, the instructions being executable by a processing circuit in a given system to cause the operations described with reference to FIG. 5. Method 500 is described below using FIG. 2 as an example embodiment. References to elements of FIG. 2 are included as non-limiting examples.

As shown, method 500 begins in block 510 with storing, by a processor circuit of the computer system based on an indication of a boot operation for the computer system, a set of permissible performance states into a performance state table in a memory circuit of the computer system. For example, processor circuit 205 may, in response to the indication of the boot operation, be configured to execute at least a portion of a boot code associated with computer system 200. The portion of boot code may include instructions that cause processor circuit 205 to store information associated with various permissible performance states into performance state tables 250 within memory circuit 260. The portion of boot code and/or the performance state information may be encoded in software or firmware that is accessible by processor circuit 205. In some embodiments, one or more of the permissible performance states allows operation of the computer system outside of specified operating parameters. For example, some or all of performance states 245 may call for an overdrive voltage that exceeds a typical maximum operating voltage level. To avoid risk of physical damage or unpredictable behavior of computer system 200, in some embodiments, use of the overdrive voltage may be limited to particular operating conditions and/or may be limited to use for a particular length of time, e.g., for 100 milliseconds, one second, and the like.

At block 520, method 500 continues with setting, by the processor circuit based on an indication that the system boot operation is complete, a hardware lock in the memory circuit to prevent changes to the performance state table. After performance state tables 240 and 250 have been populated, processor circuit 205 may set a particular configuration bit in a control register of memory circuit 260 that prevents additional write accesses to the memory locations storing performance state tables 240 and 250. Such a configuration bit may, in some embodiments, be a write-once bit that cannot be cleared until a subsequent system reset occurs, which in turn may initiate another boot operation. The hardware lock, however, does not prevent read access, at least by PMC 201, to performance state tables 240 and 250.

It is noted that method 500 includes blocks 510-520. Method 500 may end in block 520 or, in some embodiments, may repeat to initialize a different performance state table. In some embodiments, multiple instances of method 500 may be performed concurrently to initialize a different performance state tables. In various embodiments, processor circuit 205 may be included in PMC 101, and/or PMC 201 may perform the operations of block 510 and/or 520.

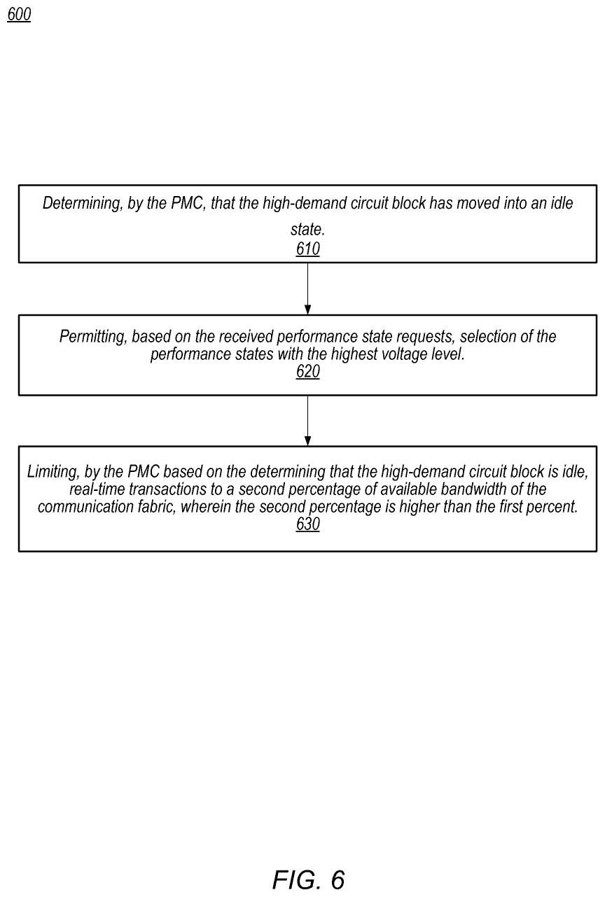

Moving to FIG. 6, a flow diagram for an embodiment of a method for a performance management circuit to select a different performance state in response to determining that a high-demand circuit block has become idle is illustrated. Similar to methods 400 and 500, method 600 may be used in conjunction with any of the computer circuitry, systems, devices, elements, or components disclosed herein, including any of computer systems 100-300. Operations of method 600 may, in whole or in part, be performed using instructions included in a non-transitory, computer-readable storage medium having program instructions being executable by a processing circuit in a given system to cause the operations described with reference to FIG. 6. Method 600 is described below using FIG. 1 as an example embodiment. References to elements of FIG. 1 are included as non-limiting examples. Operations of method 600 may, in some embodiments, occur after performing method 400, resulting in restriction of performance states with the highest voltage level.

As illustrated, method 600 begins in block 610 with the PMC determining that the high-demand circuit block has moved into an idle state. For example, PMC 101 may receive an indication that circuit block 110c has moved from an active state into an idle state. The indication may, in some embodiments, be a new performance state request from circuit block 110c that request a lower voltage for power rail 120 and/or a slower frequency for clock signal 135. In other embodiments, a processor circuit in computer system 100 may execute code that completes operations involving circuit block 110c and, in response, calls an API associated with circuit block 110c to move circuit block 110c back into the idle state. Such an API may include code to notify PMC 101 that circuit block 110c is returning to the idle state.

Method 600 continues in block 620 with the PMC permitting, based on the received performance state requests, selection of the performance states with the highest voltage level. PMC 101 may, based on determining circuit block 110c is idle, enable selection of performance states 145a-145c that were restricted when circuit block 110c was active. Based on the latest received performance state requests 115, PMC 101 may select one of performance states 145a-145c if one of performance state requests 115 corresponds to any of the previously restricted states.

At block 630, method 600 continues with the PMC limiting real-time transactions to a second percentage of available bandwidth of the communication fabric. In addition to permitting the previously restricted performance states, PMC 101 may, based on determining that circuit block 110c is idle, increase a percentage of bandwidth that is allotted to RT transaction, wherein the second percentage is higher than the first percentage that was allotted while circuit block 110c was active. For example, when circuit block 110c is active, circuit block 110c may consume a significant amount of power while simultaneously receiving and generating a number of RT transactions. In contrast, when circuit block 110c is not active, circuit block 110c is not consuming a significant amount of power and RT transactions bandwidth. Accordingly, PMC 101 may increase the RT bandwidth allocation, thereby allowing other non-high-demand circuit blocks to utilize RT transactions to complete data transactions in an efficient manner, thereby allowing these non-high-demand circuit blocks to complete tasks and return to idle states.

It is noted that method 600 includes blocks 610-630, and may end in block 630. In some embodiments, method 600 may repeat some or all operations, for example, to make further updates based on other high-demand circuit blocks that may be included. In other embodiments, multiple instances of method 600 may be performed concurrently to make updates concurrently based on the other high-demand circuit blocks.

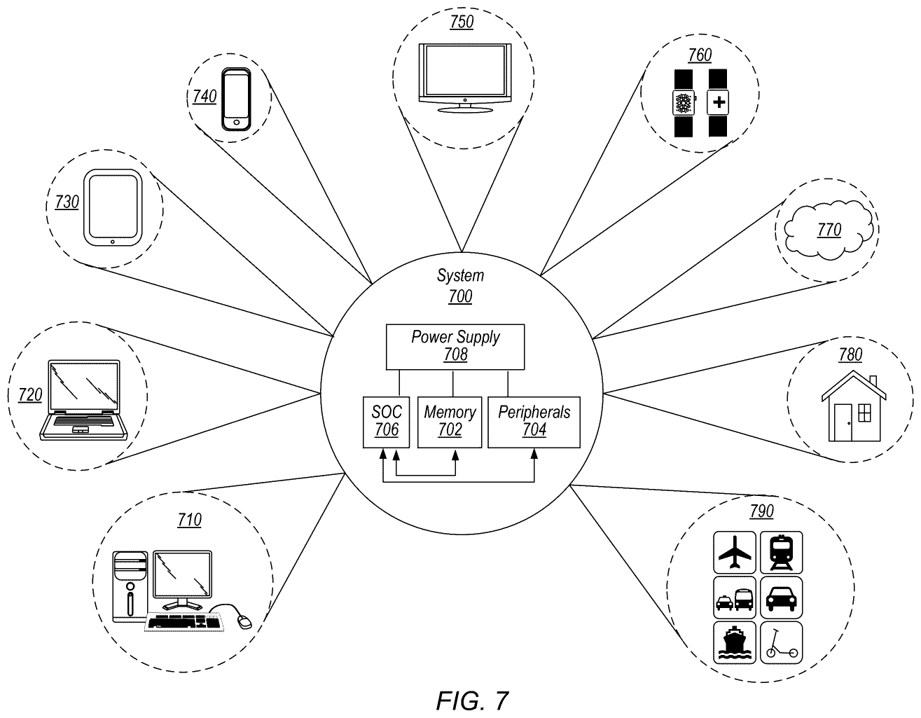

FIGS. 1-6 illustrate circuits and methods for a system, including one or more integrated circuits, that include a performance management circuit in one or more of the integrated circuits. Any embodiment of the disclosed systems may be included in one or more of a variety of computer systems, such as a desktop computer, laptop computer, smartphone, tablet, wearable device, and the like. A block diagram illustrating an embodiment of system 700 is illustrated in FIG. 7. Computer systems 100-300 in FIGS. 1-3 may, in some embodiments, correspond to system 700, or a portion thereof such as SoC 706.

In the illustrated embodiment, the system 700 includes at least one instance of a system on chip (SoC) 706 which may include multiple types of processor circuits, such as a central processing unit (CPU), a graphics processing unit (GPU), or otherwise, a communication fabric, and interfaces to memories and input/output devices. One or more of these processor circuits may correspond to an instance of the processor cores disclosed herein. In various embodiments, SoC 706 may be implemented using a single IC, or as a plurality of ICs co-packaged as a single chip (e.g., a plurality of ICs coupled internal to the package to function as a single SoC). In multi-IC embodiments, the multiple ICs may be homogeneous or heterogeneous. In various embodiments, SoC 706 is coupled to external memory circuit 702, peripherals 704, and power supply 708.

A power supply 708 is also provided which supplies the supply voltages to SoC 706 as well as one or more supply voltages to external memory circuit 702 and/or the peripherals 704. In various embodiments, power supply 708 represents a battery (e.g., a rechargeable battery in a smart phone, laptop or tablet computer, or other device). In some embodiments, more than one instance of SoC 706 is included (and more than one external memory circuit 702 is included as well).

External memory circuit 702 is any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. In some embodiments, external memory circuit 702 may include non-volatile memory such as flash memory, ferroelectric random-access memory (FRAM), or magnetoresistive RAM (MRAM). One or more memory devices may be coupled onto a circuit board to form memory modules such as single inline memory modules (SIMMs), dual inline memory modules (DIMMs), etc. Alternatively, the devices may be mounted with a SoC or an integrated circuit in a chip-on-chip configuration, a package-on-package configuration, or a multi-chip module configuration.

The peripherals 704 include any desired circuitry, depending on the type of system 700. For example, in one embodiment, peripherals 704 includes devices for various types of wireless communication, such as Wi-Fi, Bluetooth, cellular, global positioning system, etc. In some embodiments, the peripherals 704 also include additional storage, including RAM storage, solid state storage, or disk storage. The peripherals 704 include user interface devices such as a display screen, including touch display screens or multitouch display screens, keyboard or other input devices, microphones, speakers, etc.

As illustrated, system 700 is shown to have application in a wide range of areas. For example, system 700 may be utilized as part of the chips, circuitry, components, etc., of a desktop computer 710, laptop computer 720, tablet computer 730, cellular or mobile phone 740, or television 750 (or set-top box coupled to a television). Also illustrated is a smartwatch and health monitoring device 760. In some embodiments, the smartwatch may include a variety of general-purpose computing related functions. For example, the smartwatch may provide access to email, cellphone service, a user calendar, and so on. In various embodiments, a health monitoring device may be a dedicated medical device or otherwise include dedicated health related functionality. In various embodiments, the above-mentioned smartwatch may or may not include some or any health monitoring related functions. Other wearable devices 760 are contemplated as well, such as devices worn around the neck, devices attached to hats or other headgear, devices that are implantable in the human body, eyeglasses designed to provide an augmented and/or virtual reality experience, and so on.

System 700 may further be used as part of a cloud-based service(s) 770. For example, the previously mentioned devices, and/or other devices, may access computing resources in the cloud (i.e., remotely located hardware and/or software resources). Still further, system 700 may be utilized in one or more devices of a home 780 other than those previously mentioned. For example, appliances within the home may monitor and detect conditions that warrant attention. Various devices within the home (e.g., a refrigerator, a cooling system, etc.) may monitor the status of the device and provide an alert to the homeowner (or, for example, a repair facility) should a particular event be detected. Alternatively, a thermostat may monitor the temperature in the home and may automate adjustments to a heating/cooling system based on a history of responses to various conditions by the homeowner. Also illustrated in FIG. 7 is the application of system 700 to various modes of transportation 790. For example, system 700 may be used in the control and/or entertainment systems of aircraft, trains, buses, cars for hire, private automobiles, waterborne vessels from private boats to cruise liners, scooters (for rent or owned), and so on. In various cases, system 700 may be used to provide automated guidance (e.g., self-driving vehicles), general systems control, and otherwise.

It is noted that the wide variety of potential applications for system 700 may include a variety of performance, cost, and power consumption requirements. Accordingly, a scalable solution enabling use of one or more integrated circuits to provide a suitable combination of performance, cost, and power consumption may be beneficial. These and many other embodiments are possible and are contemplated. It is noted that the devices and applications illustrated in FIG. 7 are illustrative only and are not intended to be limiting. Other devices are possible and are contemplated.

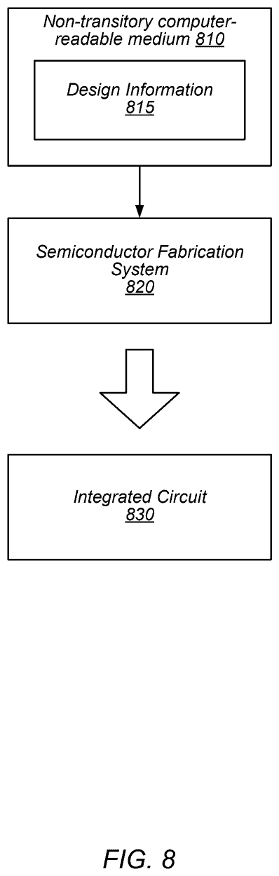

As disclosed in regard to FIG. 7, system 700 may include one or more integrated circuits included within a personal computer, smart phone, tablet computer, or other type of computing device. A process for designing and producing an integrated circuit using design information is presented below in FIG. 8.

FIG. 8 is a block diagram illustrating an example of a non-transitory computer-readable storage medium that stores circuit design information, according to some embodiments. The embodiment of FIG. 8 may be utilized in a process to design and manufacture hardware integrated circuits, for example, including one or more instances of computer systems 100-300 shown in FIGS. 1-3. In the illustrated embodiment, semiconductor fabrication system 820 is configured to process the design information 815 stored on non-transitory computer-readable storage medium 810 and fabricate hardware integrated circuit 830 based on the design information 815.

Non-transitory computer-readable storage medium 810, may comprise any of various appropriate types of memory devices or storage devices. Non-transitory computer-readable storage medium 810 may be an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 810 may include other types of non-transitory memory as well or combinations thereof. Non-transitory computer-readable storage medium 810 may include two or more memory mediums which may reside in different locations, e.g., in different computer systems that are connected over a network.

Design information 815 may be specified using any of various appropriate computer languages, including hardware description languages such as, without limitation: VHDL, Verilog, SystemC, SystemVerilog, RHDL, M, MyHDL, etc. Design information 815 may be usable by semiconductor fabrication system 820 to fabricate at least a portion of integrated circuit 830. The format of design information 815 may be recognized by at least one semiconductor fabrication system, such as semiconductor fabrication system 820, for example. In some embodiments, design information 815 may include a netlist that specifies elements of a cell library, as well as their connectivity. One or more cell libraries used during logic synthesis of circuits included in integrated circuit 830 may also be included in design information 815. Such cell libraries may include information indicative of device or transistor level netlists, mask design data, characterization data, and the like, of cells included in the cell library.

Integrated circuit 830 may, in various embodiments, include one or more custom macrocells, such as memories, analog or mixed-signal circuits, and the like. In such cases, design information 815 may include information related to included macrocells. Such information may include, without limitation, schematics capture database, mask design data, behavioral models, and device or transistor level netlists. As used herein, mask design data may be formatted according to graphic data system (gdsii), or any other suitable format.

Semiconductor fabrication system 820 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 820 may also be configured to perform various testing of fabricated circuits for correct operation.

In various embodiments, integrated circuit 830 is configured to operate according to a circuit design specified by design information 815, which may include performing any of the functionality described herein. For example, integrated circuit 830 may include any of various elements shown or described herein. Further, integrated circuit 830 may be configured to perform various functions described herein in conjunction with other components.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method). Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a computer system implemented on one or more co-packaged integrated circuits (ICs) that includes:
a plurality of circuit blocks coupled to a common power rail and clock signal, wherein at least one of the plurality of circuit blocks is designated as a high-demand circuit block;
a performance management circuit (PMC) configured to:
receive performance state requests from the plurality of circuit blocks, wherein a given one of a plurality of performance states includes a respective voltage level for the power rail and a respective frequency of the clock signal;
based on a determination that the high-demand circuit block is idle, permit selection of the performance states with a highest voltage level; and
based on a determination that the high-demand circuit block is active, limit performance state selection to a portion of the plurality of performance states that excludes performance states with the highest voltage level.

2. The apparatus of claim 1, wherein the at least one high-demand circuit block includes an image signal processor.

3. The apparatus of claim 1, further including:
a memory circuit configured to store a performance state table, and
a processor circuit configured to:
based on an indication of a system boot operation, populate the performance state table with a set of permissible performance states; and
based on an indication that the system boot operation is complete, set a lock in the memory circuit to prevent changes to the performance state table.

4. The apparatus of claim 3, wherein to populate the performance state table, the processor circuit is configured to map ones of possible combinations of table indices into the performance state table to a corresponding entry in the performance state table, wherein entries of the performance state table omit one or more possible combinations of power rail voltage level, clock signal frequency, and enabled high power circuit blocks.

5. The apparatus of claim 1, further comprising a hardware lockout circuit that is configured to block access to the portion of the performance states; and
wherein to limit the performance state selection, the PMC is configured to activate the hardware lockout circuit.

6. The apparatus of claim 5, further including a processor circuit configured to:
call an application programming interface (API) to activate the high-demand circuit block; and
send an indication of the activation of the high-demand circuit block to the PMC; and
wherein the PMC is further configured to activate, in response to the indication, the hardware lockout circuit.

7. The apparatus of claim 1, wherein the PMC is further configured to:
determine that the high-demand circuit block is idle; and
based on the received performance state requests, permit selection of the performance states with the highest voltage level.

8. The apparatus of claim 1, further including a communication fabric configured to transfer real-time (RT) transactions and bulk transactions; and
wherein the PMC is further configured to:
based on a determination that the high-demand circuit block is active, limit real-time transactions to a first percentage of available bandwidth of the communication fabric; and
based on a determination that the high-demand circuit block is idle, limit real-time transactions to a second percentage, higher than the first percentage, of available bandwidth of the communication fabric.

9. A method, comprising:
receiving, by a performance management circuit (PMC) of a computer system implemented on one or more co-packaged integrated circuits (ICs), one or more performance state requests from a respective plurality of circuit blocks, wherein a given one of a plurality of performance states includes a respective voltage level for a power rail and a respective frequency for a clock signal, and wherein at least one of the one or more performance state requests calls for a highest voltage level for the power rail;
determining, by the PMC, whether a high-demand circuit block of the plurality of circuit blocks is enabled;
based on determining that the high-demand circuit block is enabled, restricting access to a portion of the plurality of performance states, wherein the portion excludes performance states with a highest voltage level; and
selecting, by the PMC, an unrestricted one of the plurality of performance states despite the call for the highest voltage level for the power rail.

10. The method of claim 9, further comprising:
storing, by a processor circuit of the computer system based on an indication of a system boot operation for the computer system, a set of permissible performance states into a performance state table in a memory circuit of the computer system; and
setting, by the processor circuit based on an indication that the system boot operation is complete, a hardware lock in the memory circuit to prevent changes to the performance state table.

11. The method of claim 10, wherein one or more of the permissible performance states allows operation of the computer system outside of specified operating parameters.

12. The method of claim 9, wherein restricting the access to the portion of performance states includes activating, by the PMC, a hardware lockout circuit that prevents selection of the highest voltage level.

13. The method of claim 9, further comprising:
determining, by the PMC, that the high-demand circuit block has moved into an idle state; and
permitting, based on the received performance state requests, selection of the performance states with the highest voltage level.

14. The method of claim 9, further comprising limiting, by the PMC based on the determining, real-time transactions to a first percentage of available bandwidth of a communication fabric of the computer system.

15. The method of claim 14, further comprising:
determining, by the PMC, that the high-demand circuit block has moved into an idle state; and
limiting, by the PMC based on the determining that the high-demand circuit block is idle, real-time transactions to a second percentage of available bandwidth of the communication fabric, wherein the second percentage is higher than the first percentage.

16. A system comprising:
a computer system implemented on one or more co-packaged integrated circuits (ICs) that includes:
a plurality of circuit blocks, coupled to a common power rail, and configured to:
generate real-time (RT) transactions and bulk transactions, wherein the bulk transactions have a lower priority than RT transactions; and
send requests for a respective performance state of a plurality of performance states, wherein a given one of the plurality of performance states includes a respective voltage level for the common power rail;
a communication fabric configured to transfer RT transactions and bulk transactions between ones of the plurality of circuit blocks;
a power management circuit (PMC) configured to:
receive the requests for the respective performance states from the plurality of circuit blocks; and
based on a determination that a high-demand circuit block is enabled:
select, based on the received requests, one of a subset of the plurality of performance states, wherein the subset excludes performance states with a highest voltage level for the common power rail; and
limit an amount of bandwidth of the communication fabric that is allotted to RT transactions.

17. The system of claim 16, wherein the PMC is further configured to:
determine an associated frequency of a common clock source for the plurality of circuit blocks based on a current voltage level of the common power rail; and
adjust the associated frequency based a current safe operating margin.

18. The system of claim 17, wherein the PMC is further configured to increase the safe operating margin based on the determination that the high-demand circuit block is enabled.

19. The system of claim 16, wherein the PMC is further configured to:
based on a determination that the high-demand circuit block is disabled, increase the limit on the amount of bandwidth of the communication fabric that is allotted to RT transactions.

20. The system of claim 16, wherein the PMC includes a hardware lockout circuit that, when enabled, is configured to prevent the highest voltage level for the common power rail from being selected; and
wherein to exclude performance states with the highest voltage level for the common power rail, the PMC is further configured to enable the hardware lockout circuit.
